(19) United States
(12) Patent Application Publication
(10) Pub. No.: US 2018/0192245 A1
(43) Pub. Date: Jul. 5, 2018

(54) Extraction and Representation method of State Vector of Sensing Data of Internet of Things

(71) Applicant: Beijing University of Technology, Beijing (CN)

(72) Inventors: Zhiming DING, Beijing (CN); Fujie REN, Weifang (CN)

(21) Appl. No.: 15/479,317

(22) Filed: Apr. 5, 2017

(30) Foreign Application Priority Data
Dec. 30, 2016 (CN) 2016112547348

(51) Int. Cl. H04W 4/02; H04W 4/00

(52) U.S. Cl. CPC H04W 4/023; H04W 4/005; H04W 4/008

(57) ABSTRACT

The present invention discloses an extraction and representation method of state vector of sensing data of Internet of Things, extracting and representing sensing sampling data of state vector through the method. receiving sampling data and performing vector extraction on sampling data, sampling data vector representing as a time function of f(t), adding time tₛₜₐᵣₜ, end time t_{end} and unit time of vector activity of unitime, the last vector being current active vector for each component of each active sensing device; performing query of sensing sampling data, and then extracting and representing state vector, storing sensing data information with state vector, reducing update frequency of data storage and improving accuracy of interpolation query information. User inputs query time t for interpolation query, in vector sequence, obtaining vector activity corresponding time t using binary search, taking t into vector function to obtain sampling component value of monitoring object at t moment.

This application claims priority to Chinese Patent Application Ser. No. 201611254734.8 filed 30 Dec. 2016.

### TECHNICAL FIELD

The present invention relates to the field of storage of sensing data, in particular to an extraction and representation method of state vector of sensing data of Internet of Things.

### BACKGROUND

In Internet of Things systems, a sensing data is frequently collected and uploaded, forming a heavy data calculation and storage cost. Of course, the physical state of a monitoring object remains constant or change with uniform speed according to a certain pattern most of the time. If the physical state of a monitoring object can be described by a state vector, the scale of data can be greatly reduced.

Based on the above ideas, we propose a very promising solution for extraction of state vector. Wherein, the “state vector” is defined as the state change mode of monitoring object. Because the state of perceptive and monitoring object of Internet of Things is usually in accordance with a certain law for a long time (such as cars maintaining a uniform speed on a road, maintaining stabilizing and increasing of temperature of an oil depot at a constant rate for a long time), we can use the vector to describe state of monitoring object for a long time, so as to ensure the accuracy of data and greatly reduce the cost for updating and storage of sensing data. The amount of data based on vector data query and analysis is not only greatly reduced through this method, but also the update frequency of data in a vector data storage layer is effectively reduced. The above mechanism is named “data reduction”.

The technology introduces a data reduction. For storage of a sampling date, it is usually necessary to store a data and update a storage layer for receiving sampling date at once. And data reduction storage technology reduces the number of storage and update frequency. When the sampling date is stored, the state vector of the monitoring object is stored. When a new sampling date of the monitoring object arrives, a sampled value is compared with current active vector. If the difference between actual sampled value and calculated vector value is less than set threshold u, vector activity does not need to update. Only when the actual sample value deviates from the current active vector (ie, the deviation of the two exceeds specified threshold), the activity vector does need to re-update and upload. As update rate of a vector is much lower than sampling speed of a data, the data update frequency of the vector storage layer can be effectively reduced through the above method, so calling data reduction. The specific process is shown in FIG. 4, because the difference of the gray sampled value in FIG. 4 (b) and its state vector is greater than u, and then regenerating another v=f₂(t) state vector mode by v=f₁(t).

At the same time for extraction of spatiotemporal state vector, the technique introduces Bézier curve, which is a mathematical function applying to graphic application and draws a smooth curve according to arbitrary point of four positions. The Bézier curve contains three kinds of: first-order Bézier curve, second-order Bézier curve and third-order Bézier curve. The first-order Bézier curve is given two points of p₀, p₁. Linear Bézier curve is just a straight line of p₁ between two points, this line is given by: B(t)=(1−t) p₀+t p₁, tϵ[0,1]. The path of the second-order Bézier curve is tracked by a function B(t) of p₀, p₁, p₂: B(t)=p₀(1−t)²+2t (1−t)p₁+t²p₂, tϵ[0,1]. The third-order Bézier curve is defined by four points of p₀, p₁, p₂, p₃ in a plane or in a three-dimensional space. The curve starts at p₀ and goes to p₁, and from p₂ to p₃, p₀ and p₃ as start and end points of the curve, and p₁ and p₂ as control point curve do generally not go through from these two points; these two points of p₁ and p₂ only provide direction information. The spacing between p₀, and p₁ determines how long of the curve when the curve turns into toward p₃ and goes p₂ direction. The curve is given by: B(t)=p₀(1−t)³+3p₁t (1−t)²+3p₂t²(1−t)+p₃t³, tϵ[0,1].

In this technique, a threshold value u is defined. Seting sampling point data format of (tₙ, yₙ) (tₙ, yₙ respectively represents sampling time of n-th sampling data, a value corresponding a characteristic of the monitoring object). When a new sampling point data is input, the model will use the current active vector corresponding to the [tₙ₋₂, tₙ₋₁] time period to calculate the state value y corresponding to the time tₙ, and then making the difference comparison between y and yₙ. If the difference is less than the threshold, the data storage layer does not need to be updated, just to be marked the sampling point (tₙ, yₙ) as the latest sampling point; otherwise, the data storage layer need to update and upload vector activity. The use of threshold u is more in line with the actual environment. For example, using track data as a example, monitoring vehicle location information, vehicles travels on a straight line, and can not be strictly in accordance with the straight line, such as overtaking, lane change, so collected dates are not in the same vector by strictly determining, but the actual situation is driving the same vector, so determining by adding threshold to make the technology more practical.

In the technology, the state vector is extracted and stored in a vector sequence in time sequence when the state vector extracts sampling date, so a binary search algorithm can be directly used to find the vector sequence when the feature information of the monitoring object is searched. The binary search algorithm is also known as binary search method, which makes full use of order relation between elements, using divide and conquer strategy to complete the search task in the worst case O (log n).

Vector data is organized in terms of “Atomic Monitoring object”. Each monitoring object has a unique identifier ObjID. Monitoring objects and their identification follow the following principles:

(1) Corresponding to a physical object with an ID tag or other identification tag (such as a vehicle with an RFID tag), the physical object constituting a monitoring object and whose ID being an identification of the monitoring object;

(2) In the case of non-ID tags, each sensing device (sensor or monitoring device) constituting a monitoring object, and the identification of the device (that is, DevID) being used as the identification of the monitoring object.

All state vectors of the same monitoring object are organized in time series to form “state vector sequence” of the monitoring object and stored as an attribute value in the data record of the monitoring object.

### DESCRIPTION

The technical scheme adopted by the invention is an extraction and representation method of state vector of Sensing data of Internet of Things. Sensing sampling data is extracted and represented of state vector through the method. Receiving the sampling data and performing vector extraction on the sampling data. Extracted sampling data vector represents as a time function of f(t), adding time tₛₜₐᵣₜ, end time t_{end} and the unit time of the vector activity of unitime, namely: vector=(f(t), tₛₜₐᵣₜ, t_{end}, unitime). The last vector is the current active vector for each component of each active sensing device.

For the sampling value component c of the monitoring object obj, the state vector sequence can describe state change process of its long-term, expressing as follows:

VectorSequence=(v_schema,(vectorᵢ)ᵢ₌₁^{m})

The date record of the monitoring object of ObjRecord expressing as:

ObjRecord=(ObjID,ObjDescript,(Vectorsⱼ)ⱼ₌₁ⁿ,RawAddrVector)

Wherein Vectorsⱼ(1≤j≤n) is a VectorSequence type variable. ObjID is an identifier of the monitoring object. ObjDescript is a description of the monitoring object. RawAddrVector is a server address table with time stamp, which is used to calculate traceability storage server address where an original sampling record is located at a specified time.

Suppossing a state vector being vetror, s being a sensor, c being a sampling component of the sensor s. Multiple consecutive sampling value of the sampling component c of the sensor s constitutes a line segment 1 of 2D super plane of V_{χ}T. V and T are respectively sampling value and sampling time range. In vector extraction, performing fitting by discrete points, fitting the line segment 1 of the sampling value into a group of curve segment in the plane of V_{χ}T. A vehicle uniform motion as an example, the state vector representation of a sampling component f(T) and time t is shown as FIG. 5(a). Four state vectors of \textcircled{1} of FIG. 5(b) (one variable functio), \textcircled{2} (logarithmic curve), \textcircled{3} (parabola), \textcircled{4} (sine function) are gradually matched, replaced and updated.

Sensing data can be divided into three categories through extracted value from Sensing sampling data of Internet of Things: time-value sampling data, time-space sampling data and multimedia sampling data, wherein, Value of vector extraction of the time-value sampling data and time-space sampling data can be obtained by fitting of Sensing data. In the multimedia sampling data aspect, relevant semantic information can be derived by means of multimedia analysis (using existing mature image segmentation, feature extraction and other methods). The semantic information can be expressed as a formatted XML document with a pattern and represented into DerivedValue=(t, pos, schema, value) form, and the value is more String form. This technology focuses on extraction of state vectors of sampling data of sensor.

When a new two-dimensional sampling data point P(t,y) and a three-dimensional sampling data point P(t,x,y) are received, t represents a sampling time, and x and y represent a characteristic value of the monitoring object. The representation format of the following data points is the same. First, new sampling value is compared with the current active vector. If the difference between the actual sampling value and the calculated value of the vector exceeds a threshold value, then the active vector needs to be recalculated and stored. The active vector is represented by a vector function, so that the storage of the active vector only needs to store the vector function. After extraction of the state vector is finished, user performs a specific interpolation query operation. When the user inputs a time t, binary search algorithm is used to find the corresponding vector function in the vector sequence, and then obtaining characteristic value corresponding of the user at time t.

An extraction and representation method of state vector of Sensing data of Internet of Things, including the following steps of:

Step one: inspiring by the Bézier curve fitting algorithm, designing a state vector function to extract the state vector of the two dimensional sensing data;

Step 1.1: performing extraction of the vector activity of a sampling value component C₁ (two-dimensional data) of a monitoring object obj, and first of all, processing first three sampling points of received sampling data.

When the first sampling data P₁(t₁,y₁) is received, defining data type variable Pₑₚ of a sampling point, assigning P₁ to Pₑₚ, and when the second sampling data P₂(t₂,y₂) is received, constructing a state vector function of first-order Bézier curve using two data points of Pₑₚ and P₂. The vector function is stored in List [0] (List [ ] is an ArrayList <Function> type, Function is the class of a custom storage state vector), storing starting time. Defining data type variable Pₘₚ of the sampling point, assigning Pₑₚ to Pₘₚ, and assigning P₂ to Pₑₚ. When the third sampling data point P₃(t₃, y₃) is received, t₃ is taken into vector function of the current vector activity List [0]. Calculating corresponding y value, and then y is compared with y₃. If the differences are less than a domain value u (u is a double value defined according to the actual situation), it is not necessary to update the vector function, just assigning Pₑₚ to Pₘₚ, and P₃ to Pₑₚ; otherwise, uploading and storing t₂ in vector activity List [0] for the end time of the vector activity, obtaining two control points of p₀₀ and p₀₁ through three points of Pₘₚ, Pₑₚ and P₃ using a control point generating algorithm (see step 3). The state vector function is extracted with three date points of Pₑₚ, p₀₁ and P₃. The vector function is stored in List [1]. t₂ is the starting time of the vector activity, storing in vector activity List [1], assigning Pₑₚ to Pₘₚ, and P₃ to Pₑₚ, defining the control point data type variable P_{cp} and assigning p₀₁ to P_{cp}.

Step 1.2: receiving a sampling data point Pₙ (tₙ, yₙ) (n>3), and comparing Pₙ with the current vector activity.

Obtaining vector function order in the current vector activity List[m](m<n−1) of previous data point Pₙ₋₁ of the sampling data point Pₙ, and if the vector function order is first-order function, going to step 1.2.1, if the vector function order is second-order function, going to step 1.2.2, otherwise going to step 1.2.3;

Step 1.2.1: calculating corresponding y value through taking tₙ into the vector function of the previous data point Pₙ₋₁, and comparing y with yₙ. If the differences are less than the domain value u, assigning Pₑₚ to Pₘₚ, and Pₙ to Pₑₚ; otherwise, storing end time tₙ₋₁ of vector activity List [m], obtaining control points of p₀₀ and p₀₁ of three points of Pₘₚ, Pₑₚ and Pₙ using a control point generating algorithm (see Step 3), extracting the state vector function with Pₑₚ as a starting point, Pₙ as an end point, p₀₁ as a control point. The vector function is stored in List [m+1]. Storing the starting time tₙ₋₁ of the vector activity, assigning Pₑₚ to Pₘₚ, Pₙ to Pₑₚ, and p₀₁ to P_{cp}.

Step 1.2.2: obtaining control points of p₀₀ and p₀₁ of three points of Pₘₚ, Pₑₚ and Pₙ using a control point generating algorithm, extracting the third-order Bézier function with Pₘₚ as a starting point, Pₑₚ as an end point, Pₑₚ and p₀₀ as control points, updating this function to the current vector function, judging whether Pₙ is on the current vector function under the condition that the difference value is allowed to be smaller than the threshold value; if present, assigning Pₙ to Pₑₚ, and P₀₁ to P_{cp}; otherwise, storing the end time tₙ₋₁ of the vector activity List [m]; constructing a state vector function of the second-order Bézier curve with Pₑₚ as a starting point, Pₙ as an end point, p₀₁ as a control point; storing the state vector function in List [m+1], storing the starting time tₙ₋₁ of the vector activity List[m+1], assigning Pₑₚ to Pₘₚ, Pₙ to Pₑₚ, and p₀₁ to P_{cp}.

Step 1.2.3: judging whether Pₙ is on the vector function under the condition that the difference value is allowed to be smaller than the threshold value u, if present, assigning Pₑₚ to Pₘₚ, and Pₙ to Pₑₚ, otherwise, storing the end time tₙ₋₁ of the vector activity List [m], obtaining control points of p₀₀ and p₀₁ of three points of Pₘₚ, Pₑₚ and Pₙ using a control point generating algorithm (see Step 3), constructing a state vector function with Pₑₚ as a starting point, Pₙ as an end point, p₀₁ as a control point, storing the vector function in the vector of List [m+1], storing the starting time tₙ₋₁ of the vector activity List [m+1], assigning Pₑₚ to Pₘₚ, Pₙ to Pₑₚ, and p₀₁ to P_{cp}.

Step 1.3: receiving a new sampling data point to judge whether it is empty. If it is not empty to go to step 1.2; otherwise, returning vector sequence.

Step two: inspiring by the Bézier curve fitting algorithm, designing a state vector function to extract the state vector of the three dimensional sensing data;

Step 2.1: performing extraction of the vector activity of a sampling value component C₂ (three-dimensional) of a monitoring object obj, and first of all, processing received first three sampling data.

When the first sampling data P₁(t₁,x₁,y₁) is received, defining data type variable Pₑₚ of a sampling point, assigning P₁ to Pₑₚ, and when the second sampling data P₂(t₂, x₂, y₂) is received, constructing a state vector function of first-order Bézier curve using two data points of Pₑₚ and P₂; storing the vector function in List [0] (List [ ] being an ArrayList <Function> type, Function being the class of a custom storage state vector), storing starting time, defining data type variable Pₘₚ of the sampling point, assigning Pₑₚ to Pₘₚ, and assigning P₂ to Pₑₚ, when the third sampling data point P₃(t₃,x₃,y₃) is received, taking t₃ into the vector function of the current vector activity List [0], calculating corresponding x and y value, and then comparing x with x₃, and y with y₃, if the differences are less than a domain value u (u being a double value defined according to the actual situation), no need to update the vector function, just assigning Pₑₚ to Pₘₚ, and P₃ to Pₑₚ; otherwise, uploading and storing t₂ in vector activity List [0], marking the end time of the vector activity, extracting x and y components of every point of three points of Pₘₚ, Pₑₚ and P₃, obtaining two control points of p₀₀ and p₀₁ through using a control point generating algorithm (see step 3), extracting the state vector function with three date points of Pₑₚ, p₀₁ and P₃, storing the vector function in List [1], t₂ being the starting time of the vector activity, storing in vector activity List [1], assigning Pₑₚ to Pₘₚ, and P₃ to Pₑₚ, defining two-dimensional data type variable P_{cp} and assigning p₀₁ to P_{cp}.

Step 2.2: receiving a sampling data point Pₙ (tₙ, xₙ, yₙ) (n>3), and comparing Pₙ with the current vector activity.

Obtaining vector function order in the current vector activity List[m](m<n−1) of previous data point Pₙ₋₁ of the sampling data point Pₙ, and if the vector function order is first-order function, going to step 2.2.1, if the vector function order is second-order function, going to step 2.2.2, otherwise going to step 2.2.3;

Step 2.2.1: calculating corresponding x and y value through taking tₙ into the vector function of the previous data point Pₙ₋₁, and comparing xₙ with x, yₙ with y. If the differences are less than the domain value u, assigning Pₑₚ to Pₘₚ, and Pₙ to Pₑₚ; otherwise, storing end time tₙ₋₁ of vector activity List [m], extracting x and y component of three points of Pₘₚ, Pₑₚ and Pₙ, obtaining control points of p₀₀ and p₀₁ of using control point generating algorithm (see Step 3), extracting the vector function with Pₑₚ as a starting point, Pₙ as an end point, p₀₁ as a control point. The vector function is stored in List [m+1]. Storing the starting time tₙ₋₁ of the vector activity, assigning Pₑₚ to Pₘₚ, Pₙ to Pₑₚ, and p₀₁ to P_{cp}.

Step 2.2.2: extracting x and y component of three points of Pₘₚ, Pₑₚ and Pₙ, obtaining control points of p₀₀ and p₀₁ using a control point generating algorithm (see Step 3), extracting the third-order Bézier function with Pₘₚ as a starting point, Pₑₚ as an end point, Pₑₚ and p₀₀ as control points, updating this function to the current vector function. Judging whether Pₙ is on the current vector function under the condition that the difference value is allowed to be smaller than the threshold value. If present, Pₑₚ, is assigned to Pₘₚ, Pₙ is assigned to Pₑₚ, and P₀₁ is assigned to P_{cp}; otherwise, storing the end time tₙ₋₁ of the vector activity List [m]; constructing a state vector function of the second-order Bézier curve with Pₑₚ as a starting point, Pₙ as an end point, p₀₁ as a control point. The state vector function is stored in List [m+1], storing the starting time tₙ₋₁ of the vector activity List [m+1], assigning Pₑₚ to Pₘₚ, Pₙ to Pₑₚ, and p₀₁ to P_{cp}.

Step 2.2.3: judging whether Pₙ is on the vector function under the condition that the difference value is allowed to be smaller than the threshold value u, if present, assigning Pₑₚ to Pₘₚ, and Pₙ to Pₑₚ, otherwise, storing the end time tₙ₋₁ of the vector activity List [m], extracting x and y component of three points of Pₘₚ, Pₑₚ and Pₙ, obtaining control points of p₀₀ and p₀₁ using a control point generating algorithm (see Step 3), constructing a state vector function with Pₑₚ as a starting point, Pₙ as an end point, p₀₁ as a control point, storing the vector function in the vector of List [m+1], storing the starting time tₙ₋₁ of the vector activity List [m+1], assigning Pₑₚ to Pₘₚ, Pₙ to Pₑₚ, and p₀₁ to P_{cp}.

Step 2.3: receiving a new sampling data point to judge whether it is empty. If it is not empty to go to step 1.2; otherwise, returning vector sequence.

In summary of Step 1 and Step 2, according to received sampling data, analyzing the data, extracting state vector, forming a vector sequence of all previous state vector of monitoring object. In this way, on the one hand making a relatively small amount of vector data store in the vector storage layer, which not only greatly reduces the amount of data involved on the basis of the vector sequence for data query and analysis, but also effectively reduces the frequency of the data update in the vector data storage layer. On the other hand, this storage method generates the function vector to facilitate interpolation and query, improving the accuracy rate. A number of sampling components of a monitoring object can be decomposed into multiple individuals to state vector extraction.

Step three: generating algorithm of control point;

Step 3.1: obtaining two control points of P_{A} and P_{B} of given any three consecutive data points P₁, P₂ and P₃, as shown in FIG. 6. First, the distance d₀₁ of the data points P₁ and P₂, and the distance d₁₂ of the data points P₂ and P₃ are calculated as follows:

d₀₁=Math.sqrt(Math.pow(P₂ₓ−P₁ₓ,2)+Math.pow(P_{2y}−P_{2y},2)); (1)

d₁₂=Math.sqrt(Math.pow(P₃ₓ−P₂ₓ,2)+Math.pow(P_{3y}−P_{2y},2)); (2)

Step 3.2: Seting a parameter u (u is generally between 0.3 and 0.5) to adjust the roundness of the curve, obtaining the similarity ratio fa and fb of the right triangle T and T₁, T and T₂, the formula is as follows:

fa=u*d₀₁/(d₀₁+d₁₂); (3)

fb=u*d₁₂/(d₀₁+d₁₂); (4)

Step 3.3: calculating the control points P_{A} and P_{B} according to the similarity ratios fa and fb, The formula for calculation is as follows:

P_{Ax}=P₂ₓ−fa*(P₃ₓ−P₁ₓ); (5)

P_{Ay}=P_{2y}−fa*(P_{3y}−P_{1y}); (6)

P_{Bx}=P₂ₓ+fb*(P₃ₓ−P₁ₓ); (7)

P_{By}=P_{2y}+fb*(P_{3y}−P_{1y}) (8)

To sum up, the algorithm can solve the control points by obtaining the similarity ratio and setting the parameter u to adjust the curve curvature. According to the actual situation, adjusting the size of u, making the result more reasonable.

Step four: storage representation of the state vector;

After extracting the data vector of the sampling component C₁ of the monitoring object obj, representing and storing the state vector. In the Step 1, we store the vector activity in the List, which is only a component of the monitoring object obj (such as speed, position, etc. of monitoring vehicle), representing state activity of sampling component C₁ of the monitoring object with the vector sequence:

VectorSequence=(C₁,Lidt[m]);

At this time, just extracting a component, when extracting multiple sampling value components of the monitoring object obj, representing the state vector of the obj with the monitoring object as a unit:

Obj=(ObjID,ObjDescript,(Vectorsⱼ)ⱼ₌₁ⁿ,RawAddrVector);

When the state vector of the monitoring object is represented, it needs to store the unique identifier ObjID of the monitoring object, and then briefly describing the monitoring object obj, such as detecting the running state of vehicle, detecting each index of human health status and so on. And then monitoring each monitoring object.

The vector sequence of component extraction is recorded into the monitoring object data, and one is added for each extracting one monitoring component. It needs to store original data after extracting the state vector. Although most of the data are based on the vector data to do, but sometimes the original data also needs to query. So that when representing the state vector of the monitoring object, you need to map the address of the server of raw data of monitoring object to the state vector.

In summary, when querying a monitoring component data of a monitoring object, only obtaining data records of the monitoring object according to unique label ObjID of the monitoring object, and then obtaining the monitoring component in the data record. So on the one hand, comparing to monitoring components of random distribution of each monitoring object, query efficiency is higher; on the other hand, this is conducive to data association analysis of the monitoring object.

Step five: interpolation query, typical query operation for an ObjectRecord is to the state value of the monitoring object at a given time t_{q}. We define the AtInstant operation (in the following operation definition. Both sides of the “→” sign is the data type of the input data and the output data, respectively. If there are multiple input data, they are connected with “x”):

AtInstant:ObjectRecord×TimeInsert→Samplingvalue

When performing AtInstant operation, obtaining the state value of t_{q} through interpolation method. User inputs query time t_{q}, obtaining the value of sampling components corresponding monitoring object using binary search.

Step 5.1: performing binary search for the vector function sequence to obtain the function meeting time t_{q};

Step 5.2: taking t_{q} into the function to obtain characteristic value corresponding to monitoring object at time t.

In summary, it is convenient to interpolate and query by storing perceptual data in the vector sequence, greatly improving query efficiency using the binary search method to obtain the query result.

The experimental results show that the test results obtained by this method are significant.

### BRIEF DESCRIPTION OF THE DRAWINGS

FIG. 1 is a system flow chart;

FIG. 2 is a interpolation query result graph of system;

FIG. 3 is an example of sampling data;

FIGS. 4a and 4b are vector matching diagrams;

FIGS. 5a and 5b are extraction and updating diagrams of sampling data vector;

FIG. 6 is a calculation diagram of control point;

FIG. 7a is an accuracy testing diagram of data vector extraction; FIG. 7b is a bend effect diagram;

FIG. 8a is an accuracy testing diagram of data vector extraction; FIG. 8b is a bridge effect diagram;

FIG. 9a is an accuracy testing diagram of data vector extraction; FIG. 9b is a linear trajectory effect diagram.

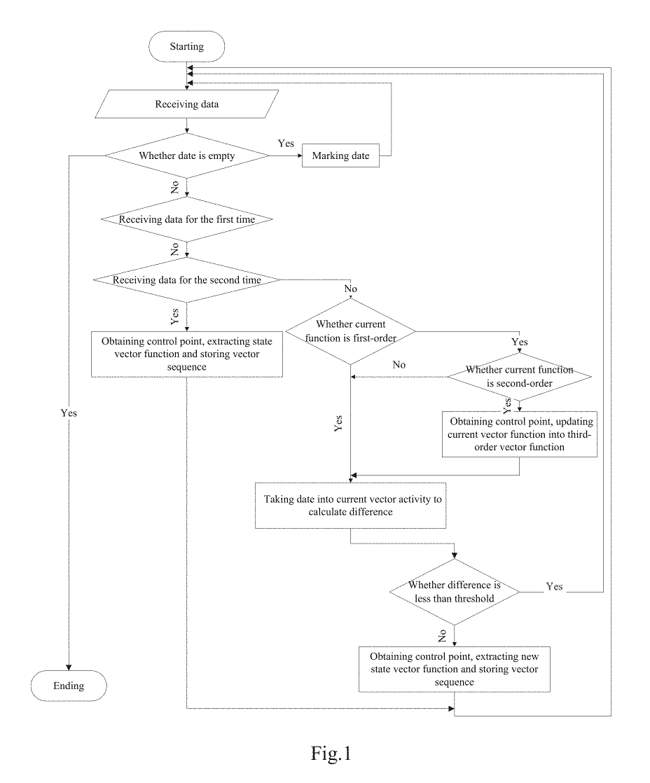

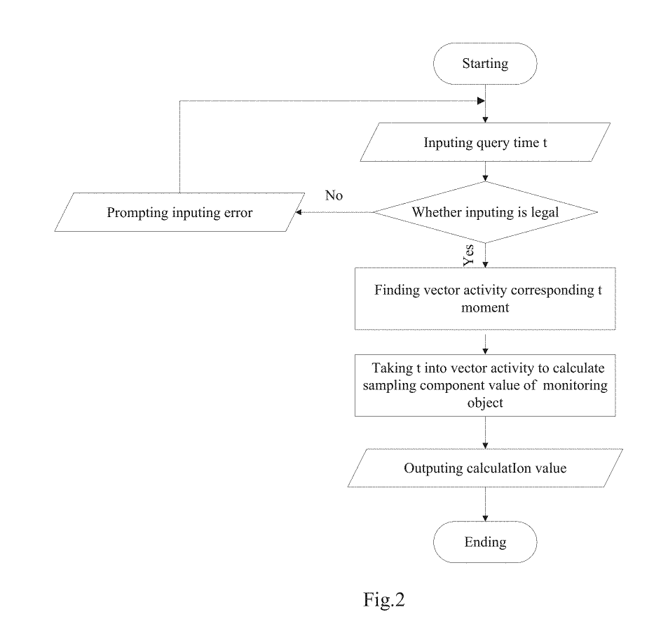

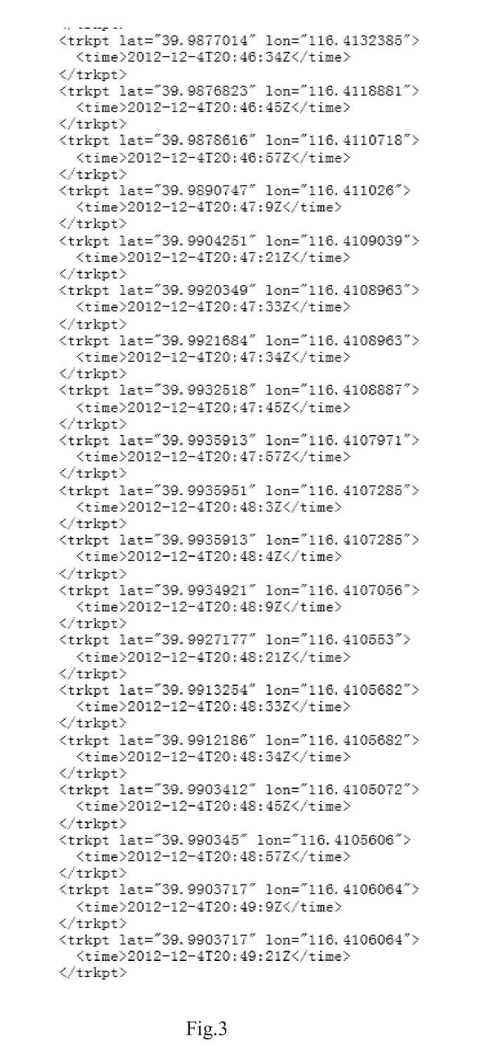

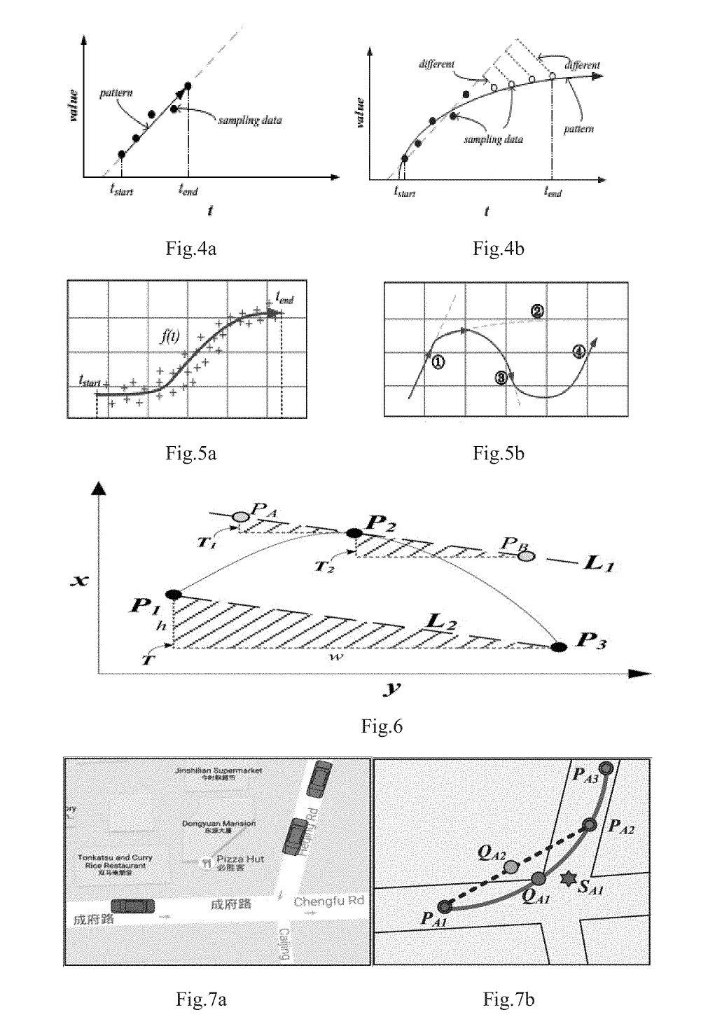

### DETAILED DESCRIPTION

The present invention will now be described in further detail with reference to the accompanying drawings as required:

The present invention is intended to illustrate the use of such methods to reduce the amount of storing data and to collect trajectory data for different time periods for different vehicles and to test the data using this method.

Step one: inspiring by the Bézier curve fitting algorithm, designing state vector extraction method of sensing data, performing state vector extraction of sampling date, and generating a vector sequence for storing track data information;

According to the track data, the position of a vehicle is marked by the latitude and longitude, and setting threshold u=−0.0005 in the case of accuracy. The vector activity is extracted and all the track data information is stored in the vector sequence. The total of the sampling data and update number of the vector activity are shown in Table 1 as follow.

TABLE 1
extraction effect of the state vector

| | | Unstored date | Reduced |
|---|---|---|---|
| Data total | Storage fuction | amount | update |
| (number) | total (number) | (number) | frequency (%) |
| 5933 | 2706 | 3227 | 54.4 |

As can be seen from Table 1, the present invention performs vector extraction of the original data, stores the state vector, and reduces the update frequency of the data storage. The original data is 5933 data points. The normal storage needs to be updated 5933 times, which only needs to update 2706 times while use of this technology. The number of data updating is decreased by about 54.4%. The effect is very significant in large data platform.

In the vector storage layer, large data representation, query and analysis based on state vector can not only reduce the speed of data update in vector storage layer, but also greatly reduce the amount of data involved in data query and analysis.

Step two: Interpolation query, performing data query based on binary search algorithm.

Obtaining time period of 2012-12-10 0:19:26-2012-12-10 6:38:18 of sampling data in a certain monitoring object, in this time period, altogether collecting 835 data points, extracting 386 vector functions. Querying the location information of the monitoring object in this time period, using binary search and order search two ways to compare.

TABLE 1
data search table

| Time | Binary search (ms) | Order search (ms) |
|---|---|---|
| 2012-12-10 0:58:23 | 0.1256 | 0.032255 |
| 2012-12-10 1:43:27 | 0.04594 | 0.051315 |
| 2012-12-10 2:10:23 | 0.051804 | 0.079173 |
| 2012-12-10 2:45 36 | 0.054736 | 0.067932 |
| 2012-12-10 3:12:45 | 0.053759 | 0.138796 |
| 2012-12-10 3:56:45 | 0.052781 | 0.087969 |
| 2012-12-10 4:34:21 | 0.04203 | 0.123157 |
| 2012-12-10 6:23:56 | 0.098721 | 0.317667 |
| 2012-12-10 6:1:34 | 0.056202 | 0.402704 |
| 2012-12-10 5:48:12 | 0.053759 | 0.245825 |
| 2012-12-10 5:34:56 | 0.063045 | 0.283945 |
| 2012-12-10 5:1:45 | 0.051315 | 0.338193 |
| 2012-12-10 4:34:56 | 0.054248 | 0.155412 |
| 2012-12-10 4:1:34 | 0.048872 | 0.248757 |
| 2012-12-10 3:45:23 | 0.059624 | 0.219923 |
| 2012-12-10 3:18:45 | 0.055714 | 0.195487 |
| 2012-12-10 2:46:28 | 0.053759 | 0.077217 |
| 2012-12-10 2:23:51 | 0.051316 | 0.126577 |
| 2012-12-10 1:58:34 | 0.054248 | 0.083082 |
| 2012-12-10 1:24:37 | 0.059624 | 0.07624 |
| 2012-12-10 0:34:56 | 0.047895 | 0.050338 |
| Average | 0.058809 | 0.194673 |

As shown in Table 2, the total time of the binary search Btime=1.234992 ms, the total time of order search: Otime=4.088124 ms. Data query based on the vector storage layer, first the amount of query data is greatly reduced. Followed by use of binary search algorithm, query efficiency is greatly enhanced. By analyzing the data in Table 2, it can be seen that the efficiency of the binary search algorithm based on vector layer is about four times of the order search, and the efficiency is more significant under large data platform.

When you need to obtain the specific location of the monitoring object at a certain time, only need to enter the query time t, querying vector function of vector sequence to obtain the corresponding function of t using binary search algorithm, taking t into the vector function to calculate the position information of the monitoring object and outputing the result. According to the sampling data in FIG. 2, the state vector is extracted to carry out interpolation query, the results shown in Table 3.

TABLE 3
interpolation query result statistical table

| Time | Lat | Lng |
|---|---|---|
| 2012-12-4T20:38:25Z | 39.9977274 | 116.4185538 |
| 2012-12-4T20:42:9Z | 39.9899063 | 116.4177246 |
| 2012-12-4T20:43:15Z | 39.9887129 | 116.4177058 |
| 2012-12-4T20:48:25Z | 39.9922560 | 116.4105430 |
| 2012-12-4T20:50:30Z | 39.9903717 | 116.4106064 |
| 2012-12-4T20:51:30Z | 39.9890686 | 116.4105574 |
| 2012-12-4T20:52:40Z | 39.9825838 | 116.4107336 |
| 2012-12-4T20:54:30Z | 39.9765276 | 116.4111618 |
| 2012-12-4T20:56:57Z | 39.9679565 | 116.4106750 |
| 2012-12-4T21:8:1Z | 39.9414531 | 116.3876917 |
| 2012-12-4T21:15:31Z | 39.9341927 | 116.3833466 |

Step three: The accuracy of state vector extraction storing data

In order to verify the accuracy of the state vector large data representation, the data under different paths are selected for verification. Usually after data storage, obtaining status of the monitoring object based on the weighted average method at specific time. The accuracy of these two representation method is compared based on crossroad, high-speed bridges, and straight paths.

(1) Based on Crossroad:

Randomly selecting three consecutive sampling data points P_{A1}(39.9915695, 116.3305054), P_{A2}(39.9916725, 116.3307266) and P_{A3}(39.9916954, 116.3307495) from the sampling data. The trajectory model of the three sampling points is shown in FIG. 7(b), which is mapped to the road network map as shown in FIG. 7(a). The monitoring object passes through the sampling points P_{A1}, P_{A2} and P_{A3} in turn. The trajectory of the monitored object through weighted average is shown as a straight line connection in the figure. The trajectory of the monitoring object is represented as curve by the state vector in the figure.

The monitoring object passes through intersection S_{A1}(39.9916436, 116.3307943), representing track in actual use by weighted average and the state vector, passing through Q_{A2}(39.9917626, 116.3309201) and Q_{A1}(39.9916436, 116.3306728), respectively. The distance between Q_{A1} and S_{A1} is 10.36 m and the distance between Q_{A2} and S_{A1} is 17.05 m by the distance between the two geographical coordinates. Since the state vector representation and the distance of the actual intersection are closer, the track state of the monitoring object representing by the state vector is more accurate at the intersection.

(2) Based on High-Speed Bridge

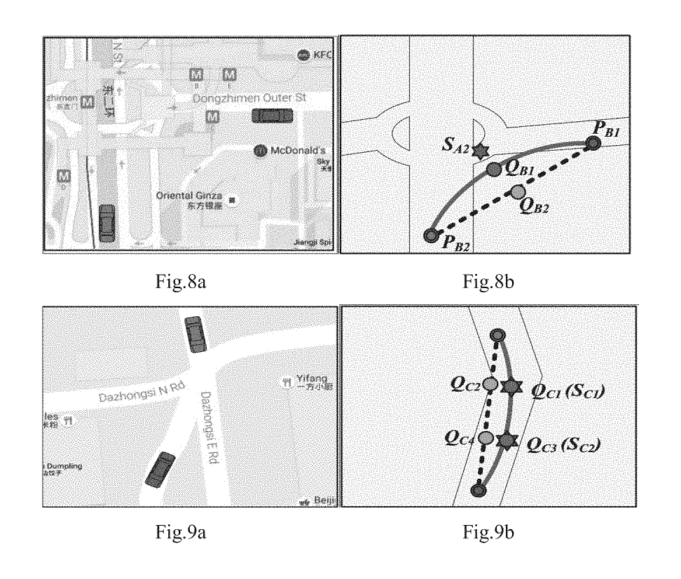

Randomly selecting three consecutive sampling data points P_{B1}(39.9396400, 116.4290695) and P_{B2}(390.9394302, 116.4276733) from the sampling data. The trajectory model of the two sampling points is shown in FIG. 8(b), which is mapped to the road network map as shown in FIG. 8(a). The monitoring object passes through the sampling points P_{B1}, and P_{B2} in turn. The trajectory of the monitored object through weighted average is shown as a straight line connection in the figure. The trajectory of the monitoring object is represented as curve by the state vector in the figure.

The monitoring object passes through intersection S_{A2}(39.9396221, 116.4286437), representing track in actual use by weighted average and the state vector, passing through Q_{B2}(39.9917626, 116.3309201) and Q_{B1}(39.9916436, 116.3306728), respectively. The distance between Q_{B1} and S_{A2} is 30.69 m and the distance between Q_{B2} and S_{A2} is 44.06 m by the distance between the two geographical coordinates. Since the state vector representation and the distance of the actual intersection are closer, the track state of the monitoring object representing by the state vector is more accurate at the high-speed bridge.

(3) Based on Straight Paths

Randomly selecting three consecutive sampling data points P_{C1}(39.9688301, 116.3327179) and P_{C2}(39.9683609, 116.3327789) from the sampling data. The trajectory model of the two sampling points is shown in FIG. 9(b), which is mapped to the road network map as shown in FIG. 9(a). The monitoring object passes through the sampling points P_{C2}, and P_{C1} in turn. The trajectory of the monitored object through weighted average is shown as a straight line connection in the figure. The trajectory of the monitoring object is represented as curve by the state vector in the figure.

Simulating vehicle trajectory according to the weighted average, taking any point Q_{4C} (39.9685420, 116.3327583) in the vehicle trajectory, The closest point on the vector trajectory from this point is Q_{C3}(39.9685420, 116.3327553). Obtaining the distance between the two points of Q_{C3} and Q_{C4} of 0.26 m according to the distance between two points in the geographical coordinates, taking a point Q_{C2}(39.9686212, 116.3327494) on the trajectory of the linear connection, The closest to this point on the vector trajectory is Q_{C1}(39.9686204, 116.3327452). Obtaining the distance between Q_{C1} and Q_{C1} of 0.37 m according to the two geographical coordinates. In the actual environment and error allowable range, we believe that the two tracks are coincident.

Based on the above experiments, it is more accurate to use the state vector to track the vehicle trajectory, especially on curved sections. The experimental results are obvious. The actual trajectory of the vehicle is mostly curve, so it is necessary to use this method.

According to a large number of experimental results, the storage update frequency and the efficiency of query and the accuracy of the method are more advantages.

What is claimed is:

1. An extraction and representation method of state vector of Sensing data of Internet of Things, being characterized by:
step one: designing a state vector function to extract the state vector of the two dimensional sensing data;
step 1.1: performing extraction of the vector activity of a sampling value component C₁ (two-dimensional data) of a monitoring object obj, and first of all, processing first three sampling points of received sampling data;
when the first sampling data P₁(t₁,y₁) is received, defining data type variable Pₑₚ of sampling points, assigning P₁ to Pₑₚ, and when the second sampling data P₂(t₂,y₂) is received, constructing a state vector function of first-order Bézier curve using two data points of Pₑₚ and P₂; storing the vector function in List [0] (List [ ] being an ArrayList <Function> type, Function being the class of a custom storage state vector), storing starting time; defining data type variable Pₘₚ of sampling points, assigning Pₑₚ to Pₘₚ, and assigning P₂ to Pₑₚ; when the third sampling data point P₃(t₃, y₃) is received, taking t₃ into the vector function of the current vector activity List [0], calculating corresponding y value, and then comparing y with y₃, if the differences are less than a domain value u (u being a double value defined according to the actual situation), no need to update the vector function, just assigning Pₑₚ to Pₘₚ, and P₃ to Pₑₚ; otherwise, uploading and storing t₂ in vector activity List [0], marking end time of the vector activity, obtaining two control points of p₀₀ and p₀₁ through three points of Pₘₚ, Pₑₚ and P₃ using a control point generating algorithm, extracting a state vector function with three date points of Pₑₚ, p₀₁ and P₃, storing the vector function in List [1], t₂ being the starting time of the vector activity, storing in vector activity List [1], assigning Pₑₚ to Pₘₚ, and P₃ to Pₑₚ, defining a control point data type variable P_{cp} and assigning p₀₁ to P_{cp};
step 1.2: receiving a sampling data point Pₙ (tₙ, yₙ) (n>3), and comparing Pₙ with the current vector activity;
obtaining vector function order in the current vector activity List[m](m<n−1) of previous data point Pₙ₋₁ of the sampling data point Pₙ, and if the vector function order is first-order function, going to step 1.2.1, if the vector function order is second-order function, going to step 1.2.2, otherwise going to step 1.2.3;
step 1.2.1: calculating corresponding y value through taking tₙ into the vector function of the previous data point Pₙ₋₁, and comparing y with yₙ, if the differences are less than the domain value u, assigning Pₑₚ to Pₘₚ, and Pₙ to Pₑₚ; otherwise, storing end time tₙ₋₁ of the vector activity List [m], obtaining control points of p₀₀ and p₀₁ of three points of Pₘₚ, Pₑₚ and Pₙ using a control point generating algorithm, extracting the state vector function with Pₑₚ as a starting point, Pₙ as an end point, p₀₁ as a control point, storing the vector function in List [m+1], storing the starting time tₙ₋₁ of the vector activity, assigning Pₑₚ to Pₘₚ, Pₙ to Pₑₚ, and p₀₁ to P_{cp};
step 1.2.2: obtaining control points of p₀₀ and p₀₁ of three points of Pₘₚ, Pₑₚ and Pₙ using a control point generating algorithm, extracting the third-order Bézier function with Pₘₚ as a starting point, Pₑₚ as an end point, Pₑₚ and p₀₀ as control points, updating this function to the current vector function, judging whether Pₙ is on the current vector function under the condition that the difference value is allowed to be smaller than the threshold value; if present, assigning Pₙ to Pₑₚ, and P₀₁ to P_{cp}; otherwise, storing the end time tₙ₋₁ of the vector activity List [m]; constructing a state vector function of the second-order Bézier curve with Pₑₚ as a starting point, Pₙ as an end point, p₀₁ as a control point; storing the state vector function in List [m+1], storing the starting time tₙ₋₁ of the vector activity List[m+1], assigning Pₑₚ to Pₘₚ, Pₙ to Pₑₚ, and p₀₀ to P_{cp};
step 1.2.3: judging whether Pₙ is on the vector function under the condition that the difference value is allowed to be smaller than the threshold value u, if present, assigning Pₑₚ to Pₘₚ, and Pₙ to Pₑₚ, otherwise, storing the end time tₙ₋₁ of the vector activity List [m], obtaining control points of p₀₀ and p₀₁ of three points of Pₘₚ, Pₑₚ and Pₙ using a control point generating algorithm, constructing a state vector function with Pₑₚ as a starting point, Pₙ as an end point, p₀₁ as a control point, storing the vector function in the vector of List [m+1], storing the starting time tₙ₋₁ of the vector activity List [m+1], assigning Pₑₚ to Pₘₚ, Pₙ to Pₑₚ, and p₀₁ to P_{cp};
step 1.3: receiving a new sampling data point to judge whether it is empty, if it is not empty, going to step 1.2; otherwise, returning vector sequence;
step two: inspiring by the Bézier curve fitting algorithm, designing a state vector function to extract the state vector of the three dimensional sensing data;
step 2.1: performing extraction of the vector activity of a sampling value component C₂ (three-dimensional) of a monitoring object obj, and first of all, processing received first three sampling data;
when the first sampling data P₁(t₁,x₁,y₁) is received, defining data type variable Pₑₚ of a sampling point, assigning P₁ to Pₑₚ, and when the second sampling data P₂(t₂, x₂, y₂) is received, constructing a state vector function of first-order Bézier curve using two data points of Pₑₚ and P₂; storing the vector function in List [0] (List [ ] being an ArrayList <Function> type, Function being the class of a custom storage state vector), storing starting time, defining data type variable Pₘₚ of the sampling point, assigning Pₑₚ to Pₘₚ, and assigning P₂ to Pₑₚ, when the third sampling data point P₃(t₃,x₃,y₃) is received, taking t₃ into the vector function of the current vector activity List [0], calculating corresponding x and y value, and then comparing x with x₃, and y with y₃, if the differences are less than a domain value u (u being a double value defined according to the actual situation), no need to update the vector function, just assigning Pₑₚ to Pₘₚ, and P₃ to Pₑₚ; otherwise, uploading and storing t₂ in vector activity List [0], marking the end time of the vector activity, extracting x and y components of every point of three points of Pₘₚ, Pₑₚ and P₃, obtaining two control points of p₀₀ and p₀₁ through using a control point generating algorithm (see step 3), extracting the state vector function with three date points of Pₑₚ, p₀₁ and P₃, storing the vector function in List [1], t₂ being the starting time of the vector activity, storing in vector activity List [1], assigning Pₑₚ to Pₘₚ, and P₃ to Pₑₚ, defining two-dimensional data type variable P_{cp} and assigning p₀₁ to P_{cp};
step 2.2: receiving a sampling data point Pₙ (tₙ, xₙ, yₙ) (n>3), and comparing Pₙ with the current vector activity;
obtaining vector function order in the current vector activity List[m](m<n−1) of previous data point Pₙ₋₁ of the sampling data point Pₙ, and if the vector function order is first-order function, going to step 2.2.1, if the vector function order is second-order function, going to step 2.2.2, otherwise going to step 2.2.3;
step 2.2.1: calculating corresponding x and y value through taking tₙ into the vector function of the previous data point Pₙ₋₁, and comparing xₙ with x, yₙ with y, if the differences are less than the domain value u, assigning Pₑₚ to Pₘₚ, and Pₙ to Pₑₚ; otherwise, storing end time tₙ₋₁ of vector activity List [m], extracting x and y component of three points of Pₘₚ, Pₑₚ and Pₙ, obtaining control points of p₀₀ and p₀₁ using control point generating algorithm, extracting the vector function with Pₑₚ as a starting point, Pₙ as an end point, p₀₁ as a control point, storing the vector function in List [m+1], storing the starting time tₙ₋₁ of the vector activity, assigning Pₑₚ to Pₘₚ, Pₙ to Pₑₚ, and p₀₁ to P_{cp};
step 2.2.2: extracting x and y component of three points of Pₘₚ, Pₑₚ and Pₙ, obtaining control points of p₀₀ and p₀₁ using a control point generating algorithm, extracting the third-order Bézier function with Pₘₚ as a starting point, Pₑₚ as an end point, Pₑₚ and p₀₀ as control points, updating this function to the current vector function, judging whether Pₙ is on the current vector function under the condition that the difference value is allowed to be smaller than the threshold value, if present, assigning Pₑₚ to Pₘₚ, Pₙ to Pₑₚ, and P₀₁ to P_{cp}; otherwise, storing the end time tₙ₋₁ of the vector activity List [m]; constructing a state vector function of the second-order Bézier curve with Pₑₚ as a starting point, Pₙ as an end point, p₀₁ as a control point, storing the state vector function in List [m+1], storing the starting time tₙ₋₁ of the vector activity List[m+1], assigning Pₑₚ to Pₘₚ, Pₙ to Pₑₚ, and p₀₁ to P_{cp};
step 2.2.3: judging whether Pₙ is on the vector function under the condition that the difference value is allowed to be smaller than the threshold value u, if present, assigning Pₑₚ to Pₘₚ, and Pₙ to Pₑₚ, otherwise, storing the end time tₙ₋₁ of the vector activity List [m], extracting x and y component of three points of Pₘₚ, Pₑₚ and Pₙ, obtaining control points of p₀₀ and p₀₁ using a control point generating algorithm, constructing a state vector function with Pₑₚ as a starting point, Pₙ as an end point, p₀₁ as a control point, storing the vector function in the vector of List [m+1], storing the starting time tₙ₋₁ of the vector activity List [m+1], assigning Pₑₚ to Pₘₚ, Pₙ to Pₑₚ, and p₀₁ to P_{cp};
step 2.3: receiving a new sampling data point to judge whether it is empty, if it is not empty, going to step 1.2; otherwise, returning vector sequence;
in summary of step 1 and step 2, according to received sampling data, analyzing the data, extracting state vector, forming a vector sequence of all previous state vector of monitoring object, in this way, on the one hand making a relatively small amount of vector data store in the vector storage layer, which not only greatly reduces the amount of data involved on the basis of the vector sequence for data query and analysis, but also effectively reduces the frequency of the data update in the vector data storage layer; on the other hand, this storage method generating the function vector to facilitate interpolation and query, improving the accuracy rate, a number of sampling components of a monitoring object capable of being decomposed into multiple individuals to state vector extraction;
step three: generating algorithm of control point;
step 3.1: obtaining two control points of P_{A} and P_{B} of given any three consecutive data points P₁, P₂ and P₃, first, calculating the distance d₀₁ of the data points P₁ and P₂, and the distance d₁₂ of the data points P₂ and P₃ as follows:
d₀₁=Math.sqrt(Math.pow(P₂ₓ−P₁ₓ,2)+Math.pow(P_{2y}−P_{2y},2)); (1)
d₁₂=Math.sqrt(Math.pow(P₃ₓ−P₂ₓ,2)+Math.pow(P_{3y}−P_{2y},2)); (2)
step 3.2: setting a parameter u (u being generally between 0.3 and 0.5) to adjust the roundness of the curve, obtaining the similarity ratio fa and fb of the right triangle T and T₁, T and T₂, the formula being as follows:
fa=u*d₀₁/(d₀₁+d₁₂); (3)
fb=u*d₁₂/(d₀₁+d₁₂); (4)
step 3.3: calculating the control points P_{A} and P_{B} according to the similarity ratios fa and fb, The formula for calculation being as follows:
P_{Ax}=P₂ₓ−fa*(P₃ₓ−P₁ₓ); (5)
P_{Ay}=P_{2y}−fa*(P_{3y}−P_{1y}); (6)
P_{Bx}=P₂ₓ+fb*(P₃ₓ−P₁ₓ); (7)
P_{By}=P_{2y}+fb*(P_{3y}−P_{1y}) (8)
to sum up, the algorithm capable of solving the control points by obtaining the similarity ratio and setting the parameter u to adjust the curve curvature, according to the actual situation, adjusting the size of u, making the result more reasonable;
step four: storage representation of the state vector;
after extracting the data vector of the sampling component C₁ of the monitoring object obj, representing and storing the state vector, in the step 1, storing the vector activity in the List, which is only a component of the monitoring object obj, representing state activity of sampling component C₁ of the monitoring object with the vector sequence:
VectorSequence=(C₁,Lidt[m]);
at this time, just extracting a component, when extracting multiple sampling value components of the monitoring object obj, representing the state vector of the obj with the monitoring object as a unit:
Obj=(ObjID,ObjDescript,(Vectorsⱼ)ⱼ₌₁ⁿ,RawAddrVector);
when the state vector of the monitoring object is represented, requiring storage of the unique identifier ObjID of the monitoring object, and then briefly describing the monitoring object obj, such as detecting the running state of vehicle, detecting each index of human health status and so on, and then monitoring each monitoring object;
recording the vector sequence of component extraction into the monitoring object data, and adding one for each extracting one monitoring component, requiring storage of original data after extracting the state vector, although most of the data are based on the vector data to do, but sometimes the original data also needs to query, so that when representing the state vector of the monitoring object, requiring mapping the address of the server of raw data of monitoring object to the state vector;
in summary, when querying a monitoring component data of a monitoring object, only obtaining data records of the monitoring object according to unique label ObjID of the monitoring object, and then obtaining the monitoring component in the data record, so on the one hand, comparing to monitoring components of random distribution of each monitoring object, having higher query efficiency; on the other hand, this being conducive to data association analysis of the monitoring object;
step five: interpolation query, typical query operation for an ObjectRecord being to the state value of the monitoring object at a given time t_{q}, defining the AtInstant operation, in the following operation definition, both sides of the “→” sign being the data type of the input data and the output data, respectively, if there being multiple input data, they being connected with “x”):
AtInstant:ObjectRecord×TimeInsert−Samplingvalue
when performing AtInstant operation, obtaining the state value of t_{q} through interpolation method, user inputing query time t_{q}, obtaining the value of sampling components corresponding monitoring object using binary search;
step 5.1: performing binary search for the vector function sequence to obtain the function meeting time t_{q};
step 5.2: taking t_{q} into the function to obtain characteristic value corresponding to monitoring object at time t;
in summary, it being convenient to interpolate and query by storing perceptual data in the vector sequence, greatly improving query efficiency using the binary search method to obtain the query result.
